(19) United States
(12) Patent Application Publication
(10) Pub. No.: US 2022/0264839 A1
(43) Pub. Date: Aug. 25, 2022

(54) ABSORBENT PET PAD

(71) Applicant: Sarah H Woo, Flushing, NY (US)

(72) Inventor: Sarah H Woo, Flushing, NY (US)

(21) Appl. No.: 17/183,243

(22) Filed: Feb. 23, 2021

(51) Int. Cl. A01K 1/015; B32B 27/06; B32B 5/02

(52) U.S. Cl. CPC A01K 1/0157; B32B 27/06; B32B 5/028; B32B 2307/726; B32B 2471/04

(57) ABSTRACT

Disclosed herein in is an absorbent pet pad and method of forming a liquid confining article. An exemplary embodiment comprises a non-rigid absorbent central region surrounded by a non-rigid or semi-rigid edge region. The edge region can be erected to an erected angle, forming a substantially vertical border surrounding the pad. The border serves to retain pet waste, and to urge a pet, instinctively, to locate itself entirely on the pad when expelling waste. The erected angle forming the border may be established and maintained with edge attachment features also referred to as angle maintaining features.

### FIELD

The present invention relates to pet waste management pads. More particularly, the present invention relates to absorbent pet pads used to confine pet waste to the surface of the pad.

### BACKGROUND

Traditional pet waste management pads may be used in the household, and other environments where it is desirable to confine the pet waste to the surface of the pad. The pet is urged and trained to use the pad when producing waste. The pads can comprise absorbent material suited to absorb the liquid elements of the pet waste.

Although washable pet waste management pads are available, the most significant commercial demand for pet pads is specifically for disposable pet pads. Disposable pet pads are particularly convenient and sanitary because they are disposed of once they become saturated with pet waste.

Conventional disposable pet pads comprise a flat, non-rigid absorbent material that is foldable and rollable so as to be convenient for storage, for packaging for distribution and sale, and for disposal. Referring to prior art FIG. 1, conventional pet pad 100 is shown deployed in a typical household environment. It will be noted that pet pad 100 is flat across its entire area, owing to the desire that it consist of a flat, non-rigid conveniently storable, packageable and disposable article. This characteristic, however, leads to significant shortcomings. In particular, since the pet pad is entirely flat, pet waste 102 tends to leak off of the area of the pet pad and onto the adjacent household floor. In addition, it is recognized that pets are inclined to position themselves in a confined space while producing waste, when such a space is presented. But because the conventional pet pad is entirely flat with no recognizable three-dimensional border, the pet will not be instinctively urged to position itself on the pad. Instead, the pet may, for example, place its front legs on the pad while waste 104 is produced entirely off of the surface of the pad.

What is desirable is a pet pad and method for using a pet pad that has all the advantages of the conventional, disposable easily stored, packaged and disposed-of pad, and also solves the shortcomings described.

### SUMMARY

An exemplary embodiment of the present invention comprises a non-rigid central region comprising an absorbent material. The central region is disposed in a first horizontal plane and comprises a central region perimeter.

In this exemplary embodiment, an edge region is disposed in substantially the first horizontal plane extending laterally away from the central region. The edge region comprises a plurality of edge sections. The plurality of edge sections are configured to fold away from the first horizontal plane forming an erected angle between 15 degrees and 165 degrees with the first horizontal plane. The edge sections each comprising edge ends.

This exemplary embodiment includes a plurality of edge attachment features. At least one of the edge attachment features is disposed substantially at at least one of the edge ends and is configured to couple edge sections to one another to maintain the erected angle.

In another exemplary embodiment, the pet pad comprises a non-rigid central region comprising an absorbent material. The central region is disposed in a first horizontal plane and comprises a central region perimeter.

In this exemplary embodiment, an edge region is disposed in substantially the first horizontal plane extending laterally away from the central region. The edge region comprising a plurality of edge sections. The plurality of edge sections are configured to fold away from the first horizontal plane forming an erected angle between 15 degrees and 165 degrees with the first horizontal plane.

This exemplary embodiment further comprises a plurality of angle maintaining features. At least one of the angle maintaining features is coupled to at least one of the edge sections and configured to maintain the erected angle.

An exemplary method embodying the present invention comprises providing an article comprising a central region comprising a first non-rigid absorbent material. The central region is disposed in a first horizontal plane and comprising a central region perimeter. The article comprises an edge region comprising the first non-rigid absorbent material disposed in substantially the first horizontal plane extending laterally away from the central region. The edge region comprising a plurality of edge sections.

The exemplary method further comprises folding the edge sections away from the first horizontal plane forming an erected angle between 15 degrees and 165 degrees with the first horizontal plane. The edge sections each comprising edge ends.

The exemplary method further comprises coupling adjacent edge ends to one another to maintain the erected angle.

### BRIEF DESCRIPTION OF DRAWINGS

These and other features, aspects, and advantages of the present invention will become better understood with regard to the following descriptions, claims, and accompanying drawings. It is to be noted, however, that the drawings illustrate only several embodiments of the invention and are therefore not to be considered limiting of the invention's scope as it can admit to other equally effective embodiments.

FIG. 1 illustrates a prior art pet pad.

FIG. 2 is a top-down view of an exemplary version of the inventive pet pad.

FIG. 3 is sectioned top view illustrating features associated with establishing an erected angle for an exemplary version of the inventive pet pad.

FIG. 4 is a sectioned side cross-section of an exemplary version of the inventive pet pad.

FIG. 5 is a sectioned side cross-section of an exemplary version of the inventive pet pad.

FIG. 6 is a sectioned side cross-section illustrating the erected angle of an exemplary version of the inventive pet pad.

FIG. 7 illustrates the erected angles of exemplary versions of the inventive pet pad.

FIG. 8 illustrates a configuration for joining adjacent edge sections to maintain an erected angle in an exemplary version of the inventive pet pad.

FIG. 9 is a perspective view of an exemplary version of the inventive pet pad in its erected state.

FIG. 10 is a sectioned perspective view illustrating a configuration for joining adjacent edge sections to maintain an erected angle in an exemplary version of the inventive pet pad.

FIG. 11 is a sectioned side view illustrating a configuration for joining adjacent edge sections to maintain an erected angle in an exemplary version of the inventive pet pad.

FIG. 12 is a perspective view of an exemplary version of the inventive pet pad in its erected state.

FIG. 13 is a sectioned top view illustrating features associated with establishing an erected angle for an exemplary version of the inventive pet pad.

FIG. 14 is a sectioned perspective view illustrating a configuration for joining adjacent edge sections to maintain an erected angle in an exemplary version of the inventive pet pad.

FIG. 15 is a top-down view of an exemplary version of the inventive pet pad.

FIG. 16 is a sectioned cross-section side view illustrating a side region erected at an erected angle is an exemplary version of the inventive pet pad.

FIG. 17 is a sectioned perspective view of an exemplary version of the inventive pet pad in its erected state.

FIG. 18 illustrates an exemplary version of the inventive pet pad deployed in an exemplary use environment.

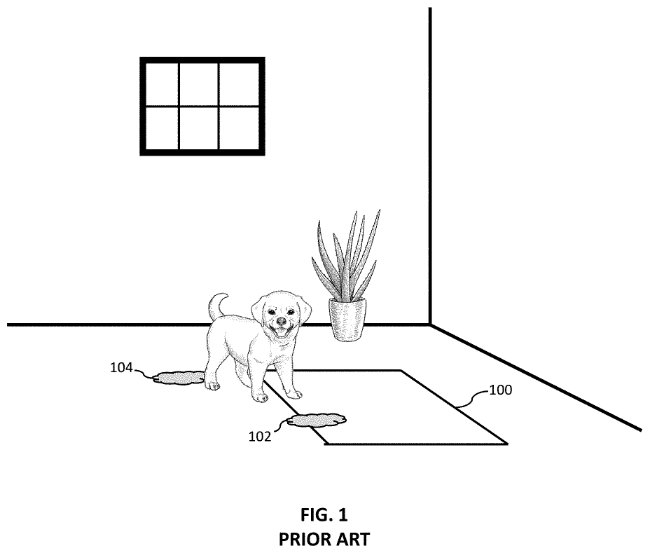

### DETAILED DESCRIPTION

So that the manner in which the features and advantages of embodiments of methods and systems of the present invention may be understood in more detail, a more particular description of the present invention briefly summarized above may be had by reference to certain embodiments thereof that are illustrated in the appended drawings, which form a part of this specification. The drawings illustrate only certain embodiments of the present invention and are, therefore, not to be considered limiting of the scope of the present invention which includes other useful and effective embodiments as well.

An exemplary version of the present invention comprises a non-rigid or largely non-rigid flat pad comprising an edge region that can be erected to an erected angle so as to provide standing edges surrounding an absorbent central region. This exemplary embodiment may be stored, packaged for distribution and sale, and disposed of, as a non-rigid or largely non-rigid flat article. And when the pad is deployed, its edges can be erected to support retaining pet waste on the pad, and to provide a three-dimensional border motivating a pet to situate itself entirely on the pad when producing waste.

Various elements of various desirable embodiments of the inventive pet pad may comprise materials of differing rigidity. For the purposes of the present detailed description of the various embodiments of the inventive pet pad, the term non-rigid should be understood to mean a material, that when folded, does not significantly deform in a manner that retains the folded shape. Examples of a non-rigid materials include cotton cloth such as that used for bedsheets, and the sheet material that comprises the disposable pet pad sold under the brand name Wee-Wee® pad. The term semi-rigid should be understood to mean a material that does not significantly resist deformation when folded and tends to retain the folded shape. Examples of semi-rigid materials include thin mil cardboard used for cereal boxes, and thick mil paper used for brown paper grocery bags.

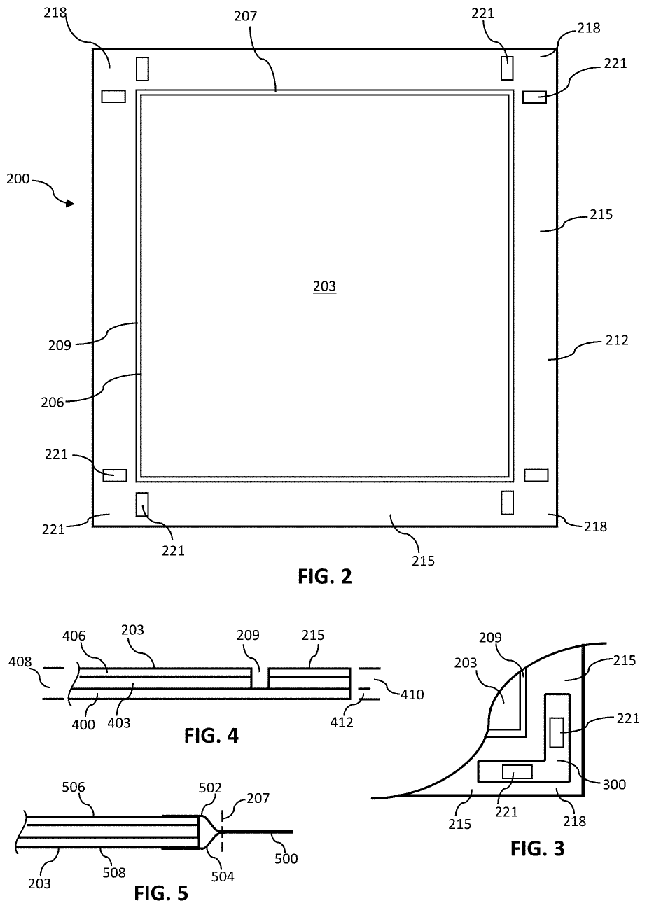

Turning to the figures, FIG. 2 is a top-down view of an exemplary version of the inventive pet pad. Pad 200 comprises a non-rigid central region 203. In this exemplary version, central region 203 comprises non-rigid liquid-absorbing absorbent material. Central region 203 comprises perimeter 206 which surrounds the lateral extent of central region 203. Perimeter 206 generally defines a fold line 207 which is substantially where edges will be folded up to an erected angle, as described in more detail below.

In this exemplary embodiment, pad 200 further comprise gap region 209. Various other desirable versions may not include a gap region. Gap region 209 resides at the junction between central region 206 and an edge region 212. Edge region 212 extends entirely around central region 203, including all four sides in the exemplary version illustrated. Edge region 212 comprises four edge sections 215. Each edge section 215 comprises two edge ends 218.

Edge attachment features 221 are disposed at edge ends 218. Edge attachment features 221 may also be referred to as angle maintaining features 221. In the illustrated exemplary version, edge attachment features 221 comprise adhesive tape, adhered on one side to a respective edge end 218, and adherable on the other side to an adjacent edge section 215 or the edge section end 218 of an adjacent edge section 215. In the illustrated version, adjacent edge ends 218 have opposing adhesive tape edge attachment features that attached to one another to erect the edge region 212 into an erected angle state as will be described in more detail below.

Turning to FIG. 3, FIG. 3 is sectional top view illustrating features associated with establishing an erected angle for an exemplary version of the inventive pet pad. More specifically, FIG. 3 shows reinforcement member 300 disposed at edge ends 218 extending from two adjacent edge sections 215. In this exemplary version, reinforcement member 300 comprises semi-rigid material such as thick mil paper in that nature of that used for brown grocery bags. As will be discussed in more detail with reference to subsequent figures, the semi-rigid reinforcement member 300 serves to aid in retaining and erected angle when the edge region 212 is erected to provide a standing border around the pet pad. Reinforcement member 300 may be attached on top of, inside of, or underneath pad 200. In the exemplary version shown in FIG. 3, opposing edge attachment features 221 are disposed on reinforcement member 300, and will adhesively connect to one another when edge region 212 is erected.

Turning to FIG. 4, FIG. 4 is a sectioned side cross-section of an exemplary version of the inventive pet pad. More specifically, FIG. 4 illustrates, for an exemplary version of the inventive pet pad, a cross section of central region 203, gap region 209 and edge section 215. In this exemplary version, central region 203 and edge section 215 comprise the same non-rigid material. The material comprises three layers. Specifically, the material comprises layer 400 which is a non-rigid non-absorbent material such as thin plastic sheeting. Additionally, the pad material comprises layer 403 which comprises a non-rigid highly liquid absorbent material for capturing the liquid elements of pet waste. Additionally, the pad material comprises layer 406 comprising a non-rigid mesh material that is less liquid absorbing than layer 403, but more durable and resistant to tearing. It will be recognized that other materials, including without limitation woven or non-woven cloth or tissue, are suitable for layer 406. Layer 406 permits liquid to reach absorbent layer 403, while maintain the structural integrity of the pet pad against deterioration and damage introduced by the pet. Non-absorbent layer 400 maintains liquid within the pad, thereby preventing leakage onto the underlying surface.

As illustrated in FIG. 4, in the exemplary version show, central region 203 has a first thickness 408. Edge section 215 has a second thickness 410. And gap region 209 has a third thickness 412. In this exemplary version, thickness 408 and 410 are substantially the same. And gap region third thickness 412 is smaller than first and second thicknesses 408 and 410. Smaller thickness 412 facilitates the folding of edge region 212 when establishing an erected angle and thereby a surrounding border.

Turning to FIG. 5, FIG. 5 is a sectioned side cross-section of an exemplary version of the inventive pet pad. This exemplary version comprises an edge region 500 comprising semi-rigid material configured to fold at fold line 207. The material may be, as just one example, thick mill paper such as that conventionally used for brown paper grocery bags. Edge region 500 divides in the direction of central region 203 into top layer 502 and bottom layer 504. Top layer 502 is attached to a top surface 506 of central region 203. Bottom layer 504 is attached to a bottom surface 508 of central region 203.

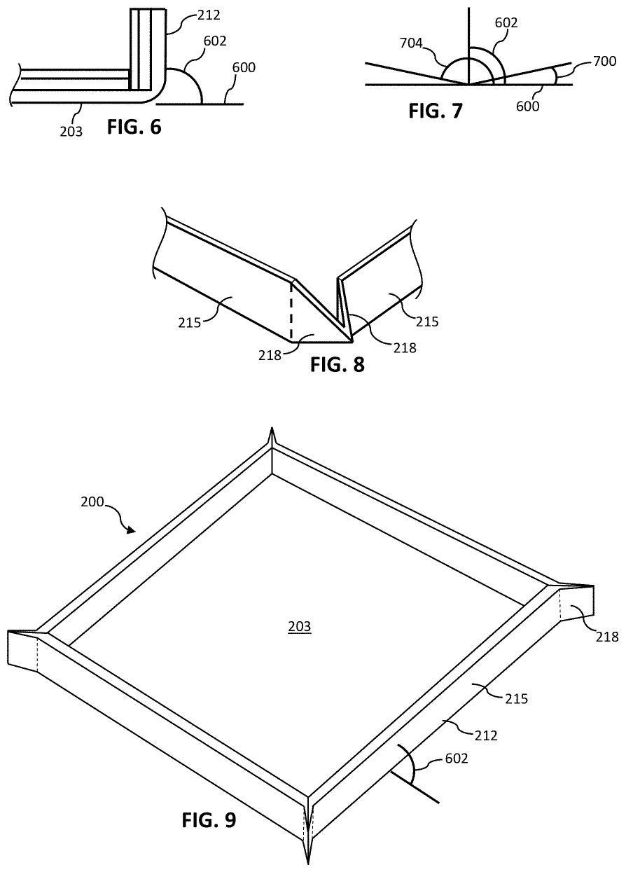

Turning to FIG. 6, FIG. 6 is a sectioned side cross-section illustrating the erected angle of an exemplary version of the inventive pet pad. Specifically, FIG. 6 illustrates edge region 212 erected so as to establish a substantially vertical border surrounding pet pad 200. Pet pad 200 lies in horizontal plane 600. Prior to folding upwards, edge region 212 also lies in horizontal plane 600. Edge region 212 and its associated edge sections 215 are configured to fold away from horizontal plane 600 to form an erected angle 602 from horizontal plane 600. Angle 602 in FIG. 6 is substantially 90 degrees from horizontal plane 600.

Turning to FIG. 7, FIG. 7 illustrates the erected angles of exemplary versions of the inventive pet pad. Horizontal plane 600 is shown. In the exemplary version, when edge region 212 is folded upward to establish a lifted border surrounding pad 200, it may be folded to and angle between and included 15 degrees, angle 700, and 165 degrees, angle 704. The folded angle may be referred to as the erected angle. The erected angle, in the illustrated version, is preferably substantially 90 degrees, angle 602.

Turning to FIG. 8, FIG. 8 illustrates a configuration for joining adjacent edge sections to maintain an erected angle in an exemplary version of the inventive pet pad. Specifically, adjacent edge ends 218 extending from adjacent edge sections 215 are joined by way of one of a variety of edge attachment features (not shown), also referred to as angle maintaining features. In the exemplary version, the edge attachment feature may comprise some or all of the elements shown in FIG. 3. Referring briefly to FIG. 3, reinforcement member 300 may be creased at its center, and opposing adhesive elements 221 may adhere to one another, thereby maintaining the erected angle, with added stability owing to the semi-rigid properties of reinforcement member 300.

Turning to FIG. 9, FIG. 9 is a perspective view of an exemplary version of the inventive pet pad in its erected state. FIG. 9 holds erected angle 602 owing to the attachment of adjacent edge ends 218 as described with reference to FIG. 8.

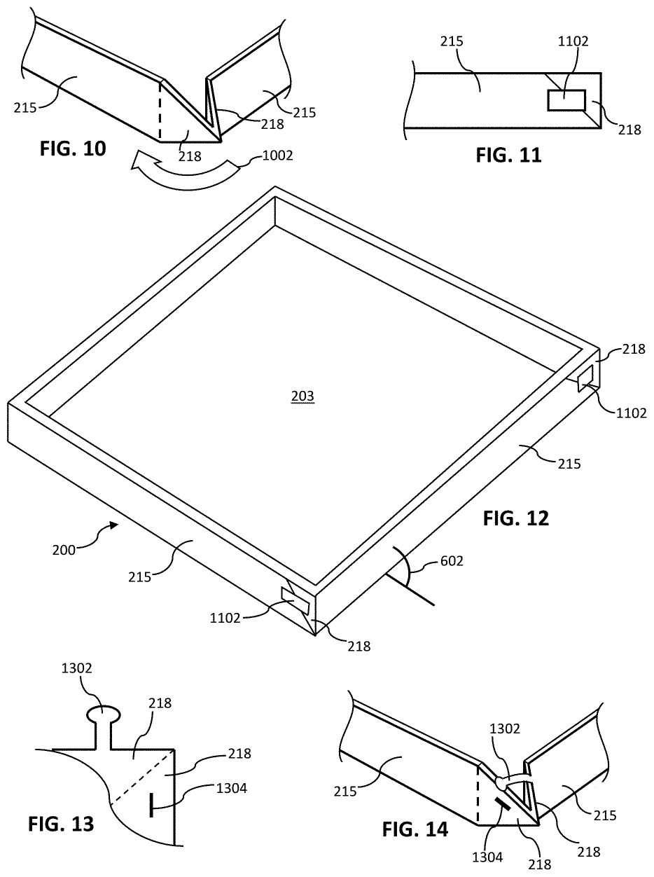

Turning to FIG. 10, FIG. 10 is a sectioned perspective view illustrating a configuration for joining adjacent edge sections to maintain an erected angle in an exemplary version of the inventive pet pad. According to the exemplary version of the inventive pet pad shown in FIG. 10, two adjacent edge ends are brought together and folded toward one of the respective edge sections 215 as illustrated by arrow 1002. Turning to figure, 11, FIG. 11 illustrates edge attachment feature 1102. In the exemplary version, edge attachment feature 1102 comprises an adhesive tape portion. The adhesive tape portion can be initially attached to edge end 218 show in FIG. 11, and can subsequently adhesively connect to edge section 215 shown in FIG. 11, to secure the corner and thereby maintain the erected angle.

Turning to FIG. 12, FIG. 12 is a perspective view of an exemplary version of the inventive pet pad in its erected state. FIG. 12 holds erected angle 602 owing to the attachment of respective edge ends 218 to adjacent edge sections 215 using edge attachment features 1102, as described above with reference to FIGS. 10 and 11.

Turning to FIG. 13, FIG. 13 is a sectioned top view illustrating features associated with establishing an erected angle for an exemplary version of the inventive pet pad. Specifically, in the exemplary version an edge end 218 comprises an integral tab 1302, and the adjacent edge end 218 comprises a corresponding slot 1304. Slot 1304 is sized slightly smaller than the wide portion of tab 1302 such that, when tab 1302 is inserted through slot 1304, tab 1302 resists withdrawing from slot 1304.

Turning to FIG. 14, FIG. 14 is a sectioned perspective view illustrating a configuration for joining adjacent edge sections to maintain an erected angle in an exemplary version of the inventive pet pad. Specifically, the configuration illustrated in FIG. 14 uses the tab 1302 and slot 1304 described with reference to FIG. 13. Adjacent edge ends 218 are brought into contact with one another, and tab 1302 is folded over and inserted fixedly through slot 1304.

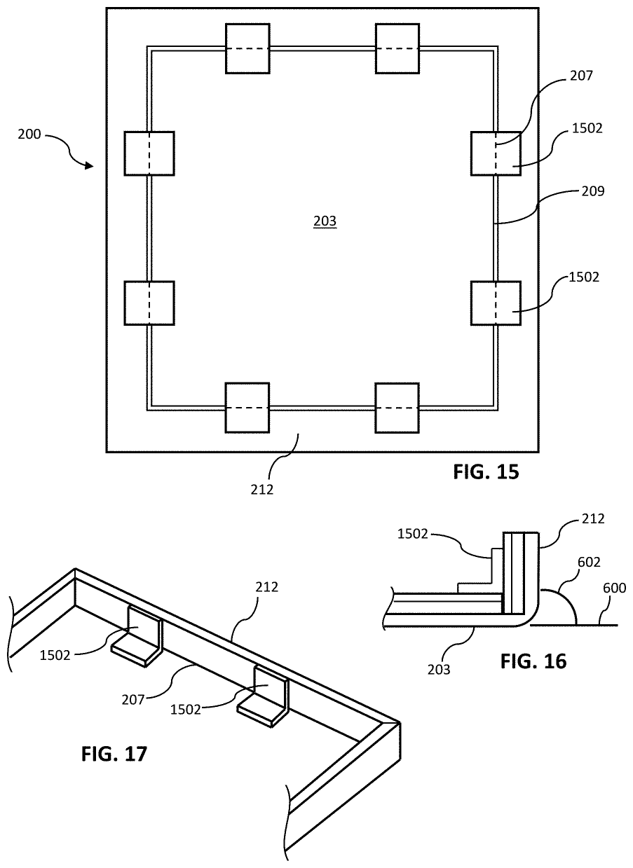

Turning to FIG. 15, FIG. 15 is a top-down view of an exemplary version of the inventive pet pad. More specifically, FIG. 15 illustrates an exemplary version of the inventive pet pad that utilizes semi-rigid reinforcement members 1502 disposed across fold line 207. In the exemplary version, a plurality of members 1502 are disturbed along respective edge sections 212. Members 1502 may be constructed for example of thick mil paper, of the nature conventionally used for brown paper shopping bags. Members 1502 are secured to pad 200 with adhesive or other suitable permanent attachment means. When edge region 212 is folded up to establish an erected angle, members 1502 are folded at fold line 207. Owing to their semi-rigid property of tending to retain their shape once folded, members 1502 serve to maintain the erected angle.

Turning to FIG. 16, FIG. 16 is a sectioned cross-section side view illustrating a side region erected at an erected angle is an exemplary version of the inventive pet pad. More specifically, FIG. 16 illustrates one of the semi-rigid reinforcement members 1502 in folded upright position. Because it is securely fixed to central region 203 and edge region 212, and owing to it's semi-rigid properties, member 1502 serves to maintain erected angle 602.

Turning to FIG. 17, FIG. 17 is a sectioned perspective view of an exemplary version of the inventive pet pad in its erected state. More specifically, FIG. 17 illustrates two the plurality of semi-rigid reinforcement members 1502 folded at fold line 207 and retaining edge section 212 at its erected angle.

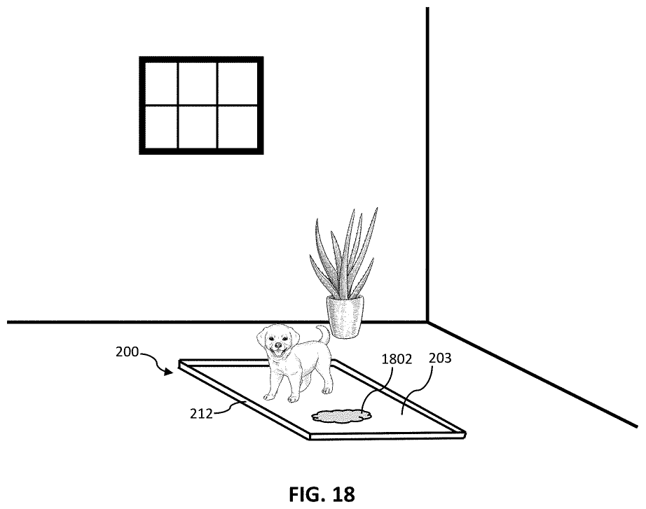

Turning to FIG. 18, FIG. 18 illustrates an exemplary version of the inventive pet pad deployed in an exemplary use environment. More specifically, FIG. 18 illustrates edge section 212 in its erected angle position, forming a substantially vertical border surrounding pad 203. Thus, an innovated pet pad is provided that may be stored, and packaged for distribution and sale, as a non-rigid or largely non-rigid flat article. And when the pad is deployed, its edges can be erected to support retaining pet waste 1802 on the pad, and to provide a three-dimensional border attracting a pet to situate itself entirely on the pad when producing waste.

The foregoing description of exemplary embodiments of the invention has been presented for the purpose of illustration; it is not intended to be exhaustive or to limit the invention to the precise forms disclosed. The description and drawings are, accordingly, to be regarded in an illustrative rather than a restrictive sense. The language used in the specification has been principally selected for readability and instructional purposes. It is therefore intended that the scope of the invention be limited not by this detailed description and drawings, but rather by any claims that issue based on this disclosure. It will be evident that various modifications and changes may be made thereto without departing from the broader spirit and scope of the invention as set forth in the claims.

1. A pet waste absorbing pet pad comprising:
a non-rigid pet waste absorbing central region comprising a first absorbent material, the pet waste absorbing central region disposed in a first horizontal plane and comprising a central region perimeter;
an integrated erectable waste retaining edge comprising;
an edge region disposed in substantially the first horizontal plane formed integrally with and extending laterally away from the pet waste absorbing central region, the edge region comprising a plurality of edge sections, the plurality of edge sections configured to fold away from the first horizontal plane forming an erected angle between 15 degrees and 165 degrees with the first horizontal plane, the edge sections each comprising edge ends; and
a plurality of edge attachment features, at least one of the edge attachment features disposed substantially at at least one of the edge ends and configured to couple edge sections to one another to maintain the erected angle; and
wherein the pet waste absorbing pet pad absorbs and retains pet waste without the addition of a second absorbent material disposed on a top surface of the pet waste absorbing central region.

2. The pet pad of claim 1, further comprising a gap region between the central region perimeter and the edge region, wherein the pet waste absorbing central region has a first thickness, the edge region has a second thickness, and the gap region has a third thickness which is smaller than the first thickness and smaller than the second thickness.

3. The pet pad of claim 2, wherein the first thickness and the second thickness are substantially the same.

4. The pet pad of claim 1, wherein the pet waste absorbing central region comprises a first material, and the edge region comprises a second material different from and more rigid than the first material.

5. The pet pad of claim 1, further comprising a semi-rigid reinforcement member disposed at at least one of the edge ends configured to support retaining the erected angle.

6. The pet pad of claim 1, wherein at least one of the plurality of edge attachment features comprises a first adhesive element attached to one of the edge ends configured to hold securely an adjacent edge section when the plurality of edge sections are folded at the erected angle.

7. The pet pad of claim 6, further comprising a second adhesive element attached to the edge end of the adjacent edge section configured to adhere to the first adhesive element.

8. The pet pad of claim 1, further comprising a semi-rigid reinforcement member disposed across a fold line located between the pet waste absorbing central region and the edge region, wherein when said reinforcement member is folded it retains its folded shape to support retaining the erected angle.

9. A pet waste absorbing pet pad comprising:
a non-rigid pet waste absorbing central region comprising a first absorbent material, the pet waste absorbing central region disposed in a first horizontal plane and comprising a central region perimeter;
an integrated erectable waste retaining edge comprising:
an edge region disposed in substantially the first horizontal plane formed integrally with and extending laterally away from the pet waste absorbing central region, the edge region comprising a plurality of edge sections, the plurality of edge sections configured to fold away from the first horizontal plane forming an erected angle between 15 degrees and 165 degrees with the first horizontal plane; and
a plurality of angle maintaining features, at least one of the angle maintaining features coupled to at least one of the edge sections and configured to maintain the erected angle; and
wherein the pet waste absorbing pet pad absorbs and retains pet waste without the addition of a second absorbent material disposed on a top surface of the pet waste absorbing central region.

10. The pet pad of claim 9, wherein at least one of the plurality of angle maintaining features comprises a first adhesive element attached to one of the edge sections configured to hold securely an adjacent edge section when the plurality of edge sections are folded at the erected angle.

11-12. (canceled)

12. The pet pad of claim 11, wherein the edge region divides in a. direction towards the pet waste absorbing central region into a top layer and a bottom layer, the top layer being coupled to a central region top surface and the bottom layer being coupled to a central region bottom surface.

13. The pet pad of claim 9, wherein at least one of the plurality of angle maintaining features comprises a tab configured to be inserted fixedly into a corresponding slot.

14. The pet pad of claim 9, wherein the pet waste absorbent central region and the edge region both comprise the same absorbent material.

15. The pet pad of claim 9, further comprising a gap region between the central region perimeter and the edge region, wherein the pet waste absorbing central region has a first thickness, the edge region has a second thickness, and the gap region has a third thickness which is smaller than the first thickness and smaller than the second thickness.

16. The pet pad of claim 15, wherein the first thickness and the second thickness are substantially the same.

17. The pet pad of claim 9, further comprising a semi-rigid reinforcement member disposed across a fold line located between the pet waste absorbing central region and the edge region, wherein when said reinforcement member is folded it retains its folded shape to support retaining the erected angle.

18-20. (canceled)

21. A pet waste absorbing pet pad comprising:
a non-rigid pet waste absorbing central region comprising a first absorbent material, the pet waste absorbing central region disposed in a first horizontal plane and comprising a central region perimeter;
an integrated erectable waste retaining edge comprising:
an edge region disposed in substantially the first horizontal plane formed integrally with and extending laterally away from the pet waste absorbing central region, the edge region comprising a plurality of edge sections, the plurality of edge sections configured to fold away from the first horizontal plane forming an erected angle between 15 degrees and 165 degrees with the first horizontal plane, the edge sections each comprising edge ends;
wherein adjacent edge sections meet at a corner point, and wherein the erected angle is established and maintained by folding the pet pad along a line in the direction of the corner point such that the respective edge ends of the adjacent edge sections are brought into contact with and coupled to one another; and
wherein the pet waste absorbing pet pad absorbs and retains pet waste without the addition of a second absorbent material disposed on a top surface of the pet waste absorbing central region.
